(19) United States
(12) Patent Application Publication
(10) Pub. No.: US 2024/0071695 A1
(43) Pub. Date: Feb. 29, 2024

(54) TERMINAL FOR AUXILIARY CONTACT

(71) Applicant: Hubbell Incorporated, Shelton, CT (US)

(72) Inventor: Robert James SIMON, Shelton, CT (US)

(21) Appl. No.: 18/237,066

(22) Filed: Aug. 23, 2023

Related U.S. Application Data
(60) Provisional application No. 63/400,076, filed on Aug. 23, 2022.

(51) Int. Cl. H01H 1/58

(52) U.S. Cl. CPC H01H 1/5855; H01H 9/0066

(57) ABSTRACT

A terminal for an electrical device having a feature to receive an auxiliary connection, the terminal including a cavity including an opening for receiving a first wire, and a terminal device positioned at least partially in the cavity, the terminal device including a distal portion extending external to the cavity, wherein the distal portion of the terminal device is configured to receive a connector of a second wire.

### FIELD OF THE INVENTION

The present disclosure relates to a terminal, and more particularly, to a terminal with a feature for auxiliary connections.

### BACKGROUND

Switches and other electric devices have terminals for receiving the connection of electrical wires. One type of terminal is a terminal screw connection in which a wire is inserted and secured with a screw. Terminal screw connections are generally intended to receive a single wire. Inserting more than one wire can result in a loose connection, particularly when the wires have different gauges. Inserting two wires without any connectors is not practical and, in some cases, may not be in compliance with UL listings for certain terminations.

In some applications, it is desired to have two wires inserted into the same terminal screw connection. For example, it may be desired to insert a main wire for power and a smaller gauge wire for voltage detection. This is sometimes done by attaching a male crimp terminal to the end of the smaller gauge wire and securing the male crimp terminal together with the larger wire in the same terminal screw connection. However, if the smaller gauge wire needs to be removed (e.g., temporarily to open or work on the switch), the terminal screw connection must be unscrewed.

There is a need for improved terminal devices that are adapted to accept multiple wires. The present invention solves these and other problems in the prior art.

### SUMMARY

An object of the present invention is to provide a terminal with a separate connection point for commercial slide-on crimp lugs, eliminating the need to put two conductors in the switch terminal, particularly where the wires are of two differing wire gauge sizes.

A further object is to provide a terminal device configured to accept a standard crimp terminal so voltage detection, control systems, and IoT system products that need to monitor the power can connect simply and without needing to disrupt the circuit.

In one exemplary embodiment according to the present disclosure, a terminal device is provided including a body having a proximal portion, a central portion, and a distal portion, the distal portion of the body configured to receive a connector exterior to a terminal, a retainer to retain the terminal device at least partially in the terminal, and optionally at least one wire guide extending down from the central portion of the body. In some embodiments, the distal portion of the body extends up at a first angle with respect to the central portion. In other embodiments, the distal portion of the body is substantially straight.

In some embodiments, the retainer to retain the terminal device at least partially in the terminal is on the proximal portion of the body. In some embodiments, the proximal portion of the body extends upward at a second angle with respect to the central portion to form the retainer. In some embodiments, the at least one wire guide includes two wire guides. The two wire guides may extend perpendicular to the central portion of the body.

In some embodiments, the proximal portion of the body has a length that is less than a length of the distal portion of the body. In some embodiments, the second angle is greater than the first angle.

In some embodiments, the central portion of the body has a top surface and a bottom surface, the bottom surface including a plurality of ribs.

Further provided is a terminal for an electrical device including a cavity including an opening for receiving a first wire, and a terminal device positioned at least partially in the cavity, the terminal device including a distal portion extending external to the cavity, wherein the distal portion of the terminal device is configured to receive a connector of a second wire. The terminal may include a screw configured to engage the terminal device against the first wire.

Further provided is an electrical device, such as a switch, including the terminal or a plurality of such terminals. The switch may include a cover extending at least partially over the plurality of terminals.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is an isometric view of a terminal device according to an exemplary embodiment of the present disclosure;

FIG. 2 is a bottom view of the terminal device shown in FIG. 1;

FIG. 3 is a side view of the terminal device shown in FIG. 1;

FIG. 4 is a bottom view of a terminal device according to an exemplary embodiment of the present disclosure;

FIG. 5 is a side view of the terminal device shown in FIG. 4;

FIG. 6 is an isometric view of a terminal device according to an exemplary embodiment of the present disclosure;

FIG. 7A is an isometric view of switch having a terminal according to an exemplary embodiment of the present disclosure;

FIG. 7B is an isometric view of switch having a terminal according to an exemplary embodiment of the present disclosure;

FIG. 8 is an isometric view of connector according to an exemplary embodiment of the present disclosure;

FIG. 9A is a side cutaway view of the switch shown in FIG. 7A; and

FIG. 9B is a side cutaway view of the switch shown in FIG. 7B.

### DETAILED DESCRIPTION

The present disclosure may be understood more readily by reference to the following detailed description of the disclosure taken in connection with the accompanying drawing figures, which form a part of this disclosure. It is to be understood that this disclosure is not limited to the specific devices, methods, conditions, or parameters described and/or shown herein, and that the terminology used herein is for the purpose of describing particular embodiments by way of example only and is not intended to be limiting of the claimed disclosure.

Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure.

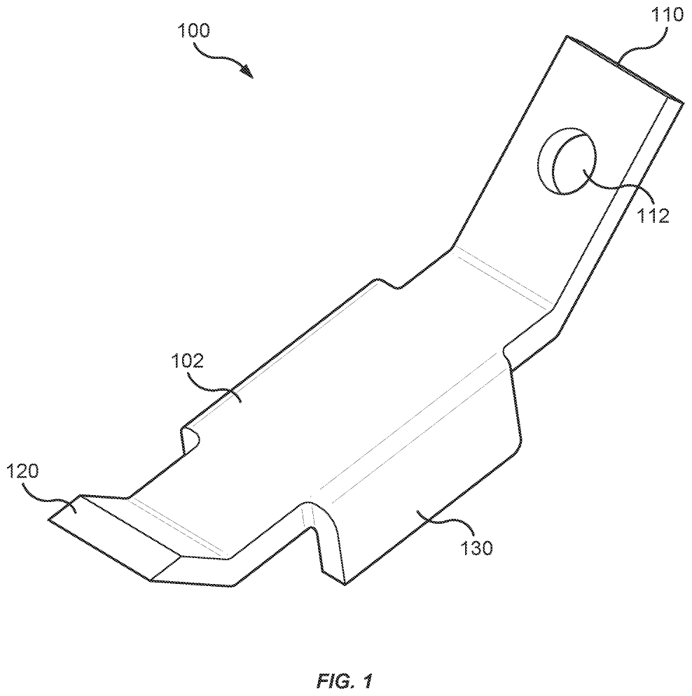

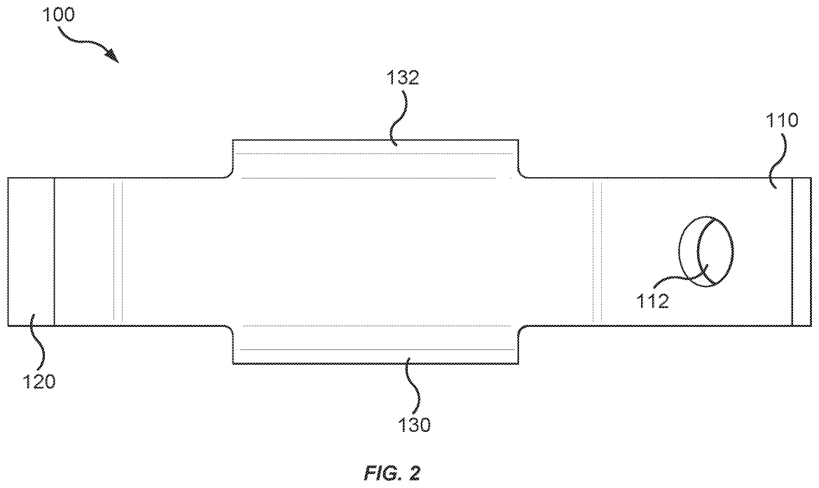

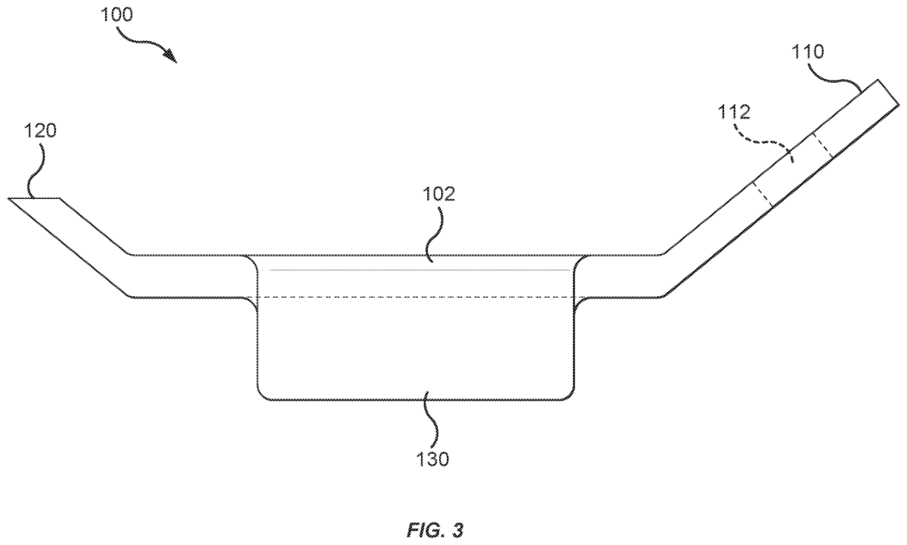

FIGS. 1-3 show a terminal device 100 according to an exemplary embodiment of the present disclosure. As discussed in more detail below, the terminal device 100 is configured for use in a terminal, e.g., a box terminal of a switch or any other electrical device, to enable attachment of two wires to the terminal. The terminal device 100 includes a body 102, a distal end 110, and a proximal end 120. The terminal device 100 is comprised of a conductive material such as a suitable metal.

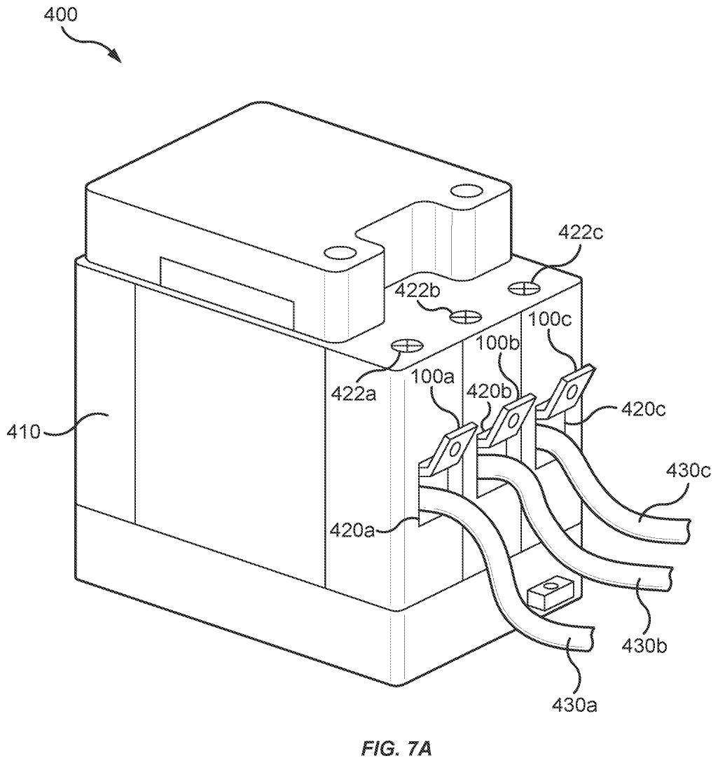

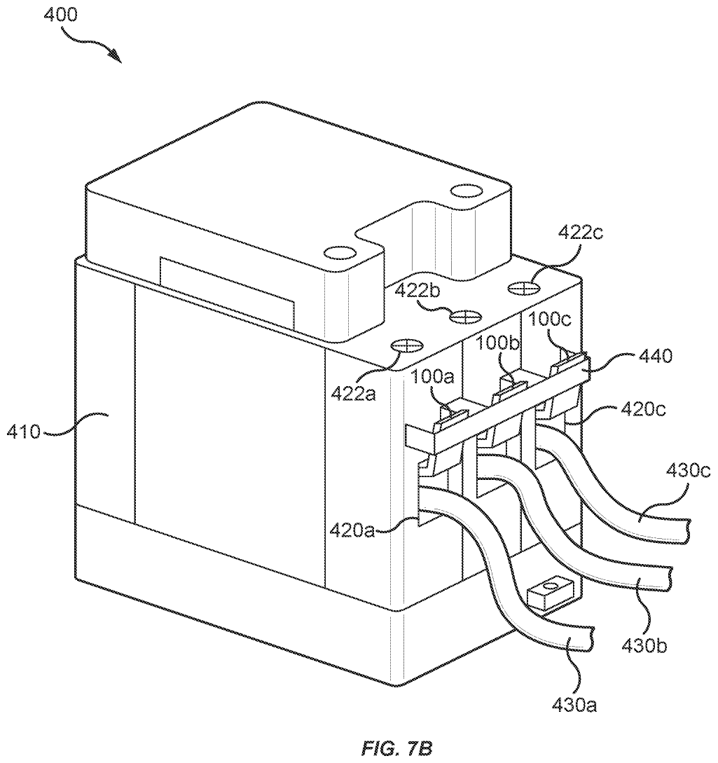

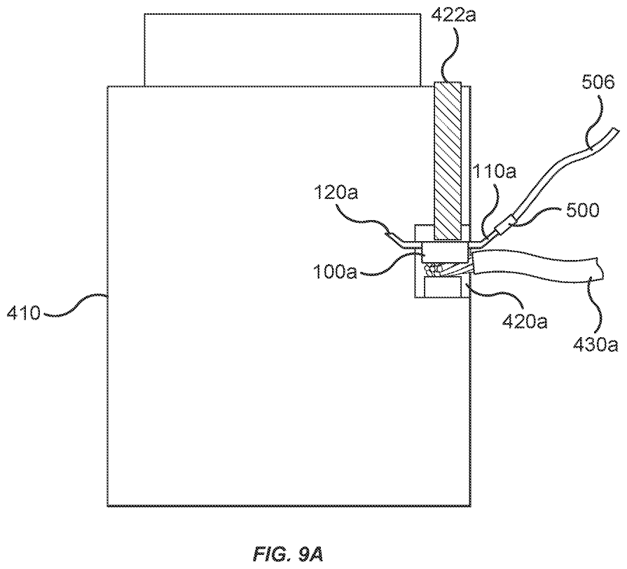

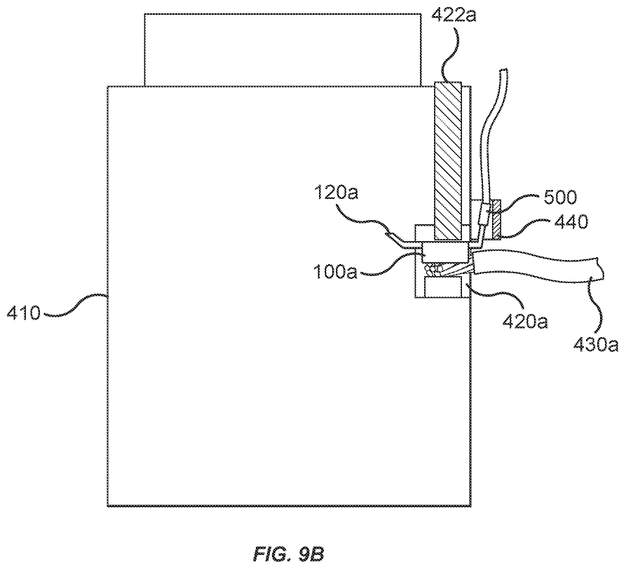

The distal end 110 is sized and shaped such that it will extend outward from a terminal, e.g., beyond an outer surface or envelope of the switch or other electrical device, when the terminal device 100 is in use. In some embodiments, the distal end 110 is curved upward at a first angle with respect to the body 102 (e.g., such as at least 30 degrees or about 45 degrees). The upward angle may, for example, enable for easier attachment of a connector to the distal end 110 when the terminal device 100 is positioned in a terminal (see, e.g., FIGS. 7A and 9A). In some embodiments, the distal end 110 is at a ninety-degree angle with respect to the body 102 (e.g., see FIGS. 7B and 9B.)

The terminal device 100 further includes a retainer or retaining feature or mechanism to retain the terminal device 100 in a box terminal without falling out. The retainer may be on the proximal end 120, though the invention is not limited thereto. For example, in some embodiments, the proximal end 120 is curved upward at a second angle with respect to the body 102 (e.g., such as at least 45 degrees, at least 60 degrees, or about 90 degrees) to engage behind an interior surface of the box terminal. In the exemplary embodiment, the first angle is less than the second angle. In the exemplary embodiment, the distal end 110 has a length that is greater than a length of the proximal end 120. In some embodiments, the proximal end 120 and/or retainer extends straight from the body 102 without having an angled portion.

The distal end 110 may include a hole 112 for facilitating wired connections, though some embodiments do not include the hole 112. In some embodiments, the distal end 110 has a removable electrically-insulating cover. The terminal device 100 may also have wings or guides 130,132 extending (e.g., downward) from a central portion of the body 102 between the distal end 110 and the proximal end 120. In the exemplary embodiment shown in FIGS. 1-3, the guides 130,132 extend approximately perpendicular to a top or bottom surface of the body 102. The guides 130,132 serve to laterally retain and/or bundle stranded conductors positioned under the terminal device 100 in a terminal.

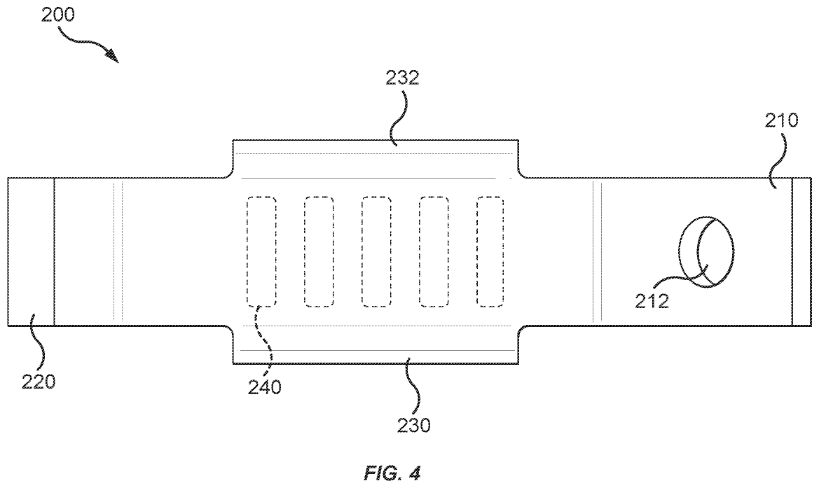

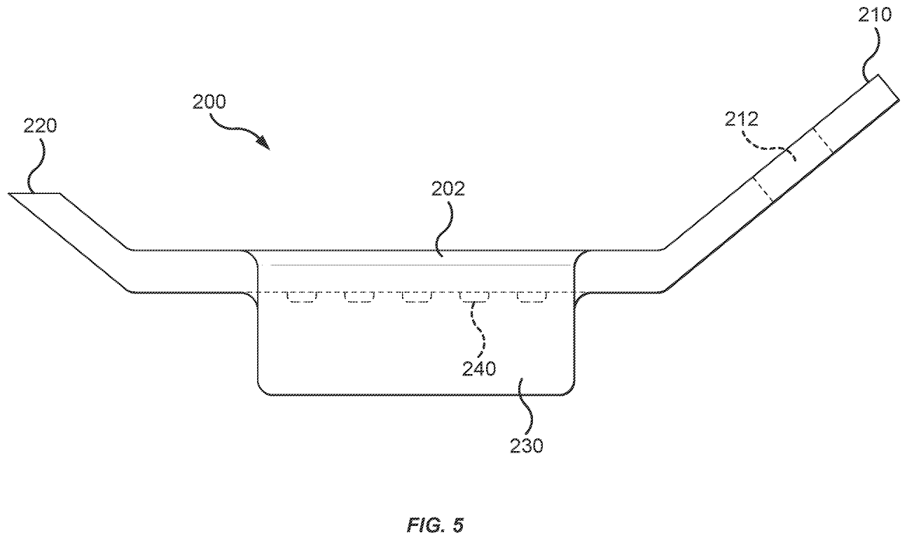

FIGS. 4-5 show a terminal device 200 according to an exemplary embodiment of the present disclosure. The terminal device 200 includes a body 202, a distal end 210, and a proximal end 220. The terminal device 200 further includes wings or guides 230,232. The guides 230,232 serve to laterally retain and/or bundle stranded conductors positioned under the terminal device 200 in a terminal. In the present embodiment, the terminal device 200 also has a plurality of ribs 240 on a bottom surface of the body 202. The ribs 240 may be formed integrally with the body 202 or mechanically attached thereto. The ribs 240 provide an improved surface for engaging with and retaining a wire and/or strands of conductors positioned under the terminal device 200.

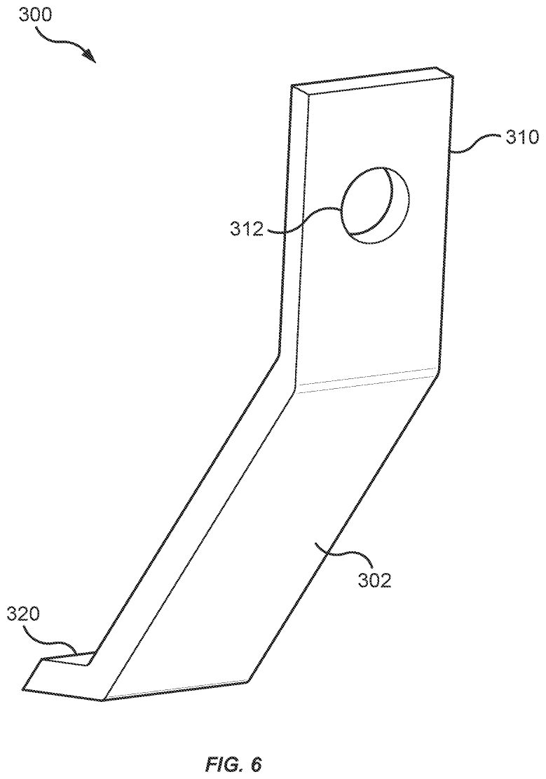

FIG. 6 shows a terminal device 300 according to an exemplary embodiment of the present disclosure. The terminal device 300 includes a body 302, a distal end 310, and a proximal end 320. In the exemplary embodiment, the terminal device 300 does not include wings or guides. In some embodiments, guides may not be necessary or desired depending on the configuration of the terminal.

FIG. 7A is switch 400 according to an exemplary embodiment of the present disclosure. The switch 400 is only exemplary and not intended to limit the invention. The invention may be used in many different types of switches and other electrical devices having terminals.

The switch 400 includes a housing 410 and plurality of terminals 420a,420b,420c (e.g., box terminals) for receiving wires 430a,430b,430c. The terminals 420a,420b,420c may be, for example, terminal screw connections having screws 422a,422b,422c for securing the wires 430a,430b,430c. The terminals 420a,420b,420c each include a terminal device 100a,100b,100c. The terminal devices 100a,100b,100c may be retained in the respective terminals 420a,420b,420c and moveable up and down.

The terminal devices 100a,100b,100c are positioned such that the distal ends thereof extend external to the terminals 420a,420b,420c, e.g., beyond an outer surface or envelope of the switch 400. As illustrated, the distal ends of the terminal devices 100a,100b,100c may be curved upward. This keeps the terminal devices 100a,100b,100c out of the way of the wires 430a,430b,430c. The curved distal ends also assist with guiding the wires 430a,430b,430c into the terminal, analogous to a funnel. As discussed above, the distal ends of the terminal devices 100a,100b,100c may each have a removable electrically-insulating cover to avoid contact with the terminal before use.

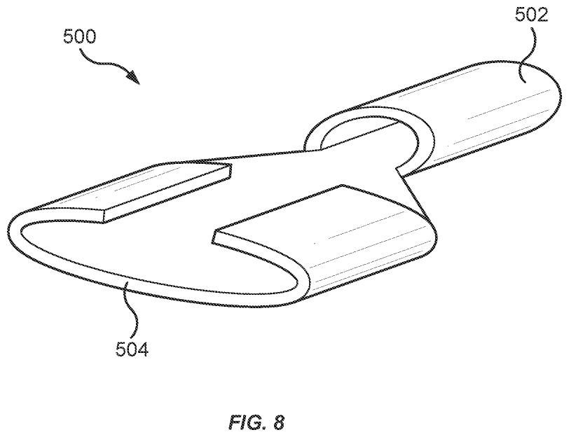

The distal ends of the terminal devices 100a,100b,100c are configured to receive various wire connections such as a female connector 500 as shown in FIG. 8. As one skilled in the art will understand, a wire may be crimped in the proximal end 502 of the connector 500. The distal end 504 is configured to slide around a distal end 110 of a terminal device 100. The connector 500 may optionally include an electrically-insulating cover. In other embodiments, the distal ends of the terminal devices 100a,100b,100c are configured as female connectors adapted to receive male connectors.

FIG. 7B shows the switch 400 including an optional cover 440 having slots and/or pockets for the terminal devices 100a,100b,100c. The distal ends 110 of the terminal devices 100a,100b,100c extend upward at an approximately ninety-degree angle within the cover 440.

FIG. 9A is a side cutaway view of the switch 400 shown in FIG. 7A. The terminal device 100a is positioned in the terminal 420a of the switch in a horizontal orientation. The distal end 120a of the terminal device 100a is configured to retain the terminal device 100a in the terminal 420a. The distal end 120a holds the moving terminal device 100 in the terminal so when the screw 422a is backed out, the terminal device 100a will not fall from the terminal cavity.

The wire 430a may be inserted in the terminal 420a adjacent to the terminal device 100a and secured therein by tightening the screw 422a. The guides 130,132 (see FIGS. 1-3) of the terminal device 100a may engage at least partially around and assist with bundling the wire 430a.

An auxiliary or second wire 506 may also be secured to the terminal 420a via the distal end 110a of the terminal device 100a (e.g., for monitoring voltage). The second wire 506 may have a smaller gauge (e.g., 18-20 gauge) than the wire 430a (e.g., 8-10 gauge) though different sizes may be used without limitation. The second wire 506 may have a female connector 500 on its end (or a male connector if the distal end 110a is configured as female connector). The female connector 500 is pressed on and secured to the distal end 110a of the terminal device 100a. The second wire 506 may be removed quickly and easily without having to open the terminal 420a.

FIG. 9B is a side cutaway view of the switch 400 shown in FIG. 7B. The terminal device 100a is positioned in the terminal 420a of the switch in a horizontal orientation. The distal end 120a of the terminal device 100a is configured to retain the terminal device 100a in the terminal 420a. The distal ends 110 of the terminal devices 100a,100b,100c extend upward at an approximately ninety-degree angle at least partially behind the cover 440. An auxiliary or second wire 506 is secured to the terminal 420a via the distal end 110a of the terminal device 100a. In particular, the connector 500 may be inserted through slot in the top of cover 440 and onto the distal end 110a.

As shown throughout the drawings, like reference numerals designate like or corresponding parts. While illustrative embodiments of the present disclosure have been described and illustrated above, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

What is claimed is:

1. A terminal device, comprising:
a body having a proximal portion, a central portion, and a distal portion;
the distal portion of the body extending at a first angle with respect to the central portion and configured to receive a connector exterior to a terminal; and
a retainer to retain the terminal device at least partially in the terminal.

2. The terminal device of claim 1, wherein the retainer to retain the terminal device at least partially in the terminal is on the proximal portion of the body.

3. The terminal device of claim 2, wherein the proximal portion extends upward at a second angle with respect to the central portion of the terminal.

4. The terminal device of claim 1, further comprising at least one wire guide extending down from the central portion of the body.

5. The terminal device of claim 4, wherein the at least one wire guide includes two wire guides extend perpendicular to the central portion of the body.

6. The terminal device of claim 1, wherein the proximal portion of the body has a length that is less than a length of the distal portion of the body.

7. The terminal device of claim 1, wherein the central portion of the body has a bottom surface including a plurality of ribs.

8. The terminal device of claim 1, wherein the distal portion of the body includes a hole extending therethrough.

9. A terminal for an electrical device, comprising:
a cavity including an opening for receiving a first wire; and
a terminal device positioned at least partially in the cavity, the terminal device including a distal portion extending external to the cavity;
wherein the distal portion of the terminal device is configured to receive a connector of a second wire.

10. The terminal of claim 9, further comprising a retainer to retain the terminal device at least partially in the terminal.

11. The terminal of claim 9, wherein the distal portion extends upward at a first angle with respect to a central portion of the terminal device.

12. The terminal of claim 11, wherein the terminal device includes a proximal portion extending upward at a second angle with respect to the central portion.

13. The terminal of claim 12, wherein the proximal portion is configured as a retainer to retain the terminal device at least partially in the terminal.

14. The terminal of claim 12, wherein the second angle is greater than the first angle.

15. The terminal of claim 9, further comprising a screw configured to engage the terminal device against the first wire.

16. The terminal of claim 9, wherein the terminal device includes two wire guides extending down from a central portion of the terminal device.

17. The terminal of claim 16, wherein the two wire guides extend perpendicular to the central portion of the terminal device.

18. The terminal of claim 9, wherein a proximal portion of the terminal device has a length that is less than a length of the distal portion of the terminal device.

19. The terminal of claim 9, wherein a central portion of the terminal device has a bottom surface including a plurality of ribs.

20. A switch comprising the terminal of claim 9, wherein the switch includes a plurality of the terminals and a cover extending at least partially over the plurality of terminals.
